(19) United States
(12) Patent Application Publication
(10) Pub. No.: US 2006/0271303 A1
(43) Pub. Date: Nov. 30, 2006

(54) Methods and systems for transferring data

(76) Inventors: Charles Manfredi, Oakhurst, NJ (US); Paul A. Larson, Newark, DE (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/137,966

(22) Filed: May 25, 2005

(51) Int. Cl. G06F 19/00

(52) U.S. Cl. 702/19; 702/22

(57) ABSTRACT

Methods and systems for transferring data, e.g., analytical device consumable data, from a source location to a target location are provided. Also provided are computer program products for executing the subject methods.

### BACKGROUND OF THE INVENTION

Analytical chemistry is the analysis of samples to gain an understanding of their chemical composition. The goal of many chemical analysis protocols is to analyze a given sample (e.g., a physiological sample, an environmental sample, a manufacturing sample, etc.) for a variety of different purposes, e.g., to identify the presence of one or more analytes of interest-in the sample, to characterize the makeup of the sample, e.g., in quality control, etc.

Many different analytical chemistry protocols have been developed. One broad category of analytical protocols that have been developed is chromatography. Chromatography is a family of analytical chemistry techniques for the separation of mixtures. In chromatography, a sample (the analyte) in a “mobile phase”, often in a stream of solvent, is passed through a “stationary phase”, where the stationary phase is some form of material that will provide retention between the components of the sample and the material. Usually, each component has a characteristic separation rate that can be used to identify it and thus the composition of the original mixture.

A chromatograph takes a chemical mixture carried by liquid or gas and separates it into its component parts as a result of differential distributions of the solutes as they flow around or over a stationary liquid or solid phase. Various techniques for the separation of complex mixtures rely on the differential affinities of substances for a gas or liquid mobile medium and for a stationary adsorbing medium through which they pass; such as paper, gelatin, or magnesium silicate gel.

Many different chromatographic analytical devices have been developed in order to perform various chromatographic protocols. Examples of various chromatographic devices include, but are not limited to: gas chromatography devices, liquid chromatography devices, capillary electrophoresis devices, and supercritical fluid chromatography devices.

Chromatographic protocols and devices typically use a wide range of consumables. The term “consumables” is used broadly to refer to any type of device or reagent that may be employed in a given protocol and/or in a given device in a temporary, e.g., one time, several time, basis, but not on a permanent basis (e.g., not for the life of the analytical device itself, or a significant portion thereof). Consumables may be reagents, e.g., standards employed for calibration, or devices, e.g., chromatographic columns.

Often, to perform a given task, data regarding a given consumable needs to be entered into a target location, e.g., a target data file used in the generation of a report or a target data file used in operation of a device according to a specific protocol. Often, the data that needs to be entered is complex, e.g., in the form of multiple long chemical names and/or a large number of quantitative data.

Currently, such data is transcribed from a source document, e.g., a label associated with the consumable, a document viewed at a vendor webpage, etc. into a target location, e.g., a chromatograph device operating system. This process of manual transcription is time consuming and error prone.

In view of the above, the inventors have realized a need for the development of an improved system of transferring data from a source to a target location, which improved system would address at least some of the deficiencies experienced with current manual transcription approaches.

### SUMMARY OF THE INVENTION

Methods for transferring data, e.g., analytical device consumable data, from a source location to a target location are provided. Aspects of the invention include an interface element that presents the data to a user in a format that includes a first subset of the data and at least a second subset of the data. A feature of the interface of the invention is that, upon selection (e.g., via a one-click protocol), the first subset is output by the interface element to a product that includes the first subset of data, e.g., where the product may be in a format that is universally understood by many different target locations, such that the format of the product is not tailored for a specific target location, but instead is in a format that may be employed by many different target locations. In certain embodiments, the source location is a publication (e.g., published by a vendor of a consumable) about the consumable, e.g., a catalog (paper or electronic), a web-page, etc., and the target location is an application program, e.g., either an “off-the-shelf” application program or a local system of a customer. The product is then transferred to the target location. Also provided are computer program products and systems for executing the subject methods.

### BRIEF DESCRIPTIONS OF THE DRAWINGS

FIG. 1 provides a flow chart representation of a first representative embodiment of the subject invention.

FIG. 2 provides a flow chart representation of a second representative embodiment of the subject invention.

FIG. 3 provides a flow chart representation of a third representative embodiment of the subject invention.

FIG. 4 schematically illustrates some methods and apparatus of the subject invention.

### DEFINITIONS

Unless defined otherwise, all technical and scientific terms used herein have the same meaning as commonly understood by one of ordinary skill in the art to which this invention belongs. Still, certain elements are defined below for the sake of clarity and ease of reference.

By “remote location,” it is meant a location other than the location at which a referenced item is present. For example, a remote location could be a location outside of the application of interest (such as a package of a consumable, where the consumable may be in the same room as the application being operated, e.g., a data system on an analytical device) or another physical location (e.g., office, lab, etc.) in the same city, another location in a different city, another location in a different state, another location in a different country, etc. As such, when one item is indicated as being “remote” from another, what is meant is that the two items are separate from each other, where they may be in the same or different rooms or different buildings, and may be at least one mile, ten miles, or at least one hundred miles apart.

“Communicating” information references transmitting the data representing that information as signals (e.g., electrical, optical, radio signals, etc.) over a suitable communication channel (e.g., a private or public network).

“Forwarding” an item refers to any means of getting that item from one location to the next, whether by physically transporting that item or otherwise (where that is possible) and includes, at least in the case of data, physically transporting a medium carrying the data or communicating the data.

A “computer-based system” refers to the hardware means, software means, and data storage means used to analyze the information of the present invention. The minimum hardware of the computer-based systems of the present invention comprises a central processing unit (CPU), input means, output means, and data storage means. A skilled artisan can readily appreciate that many computer-based systems are available which are suitable for use in the present invention. The data storage means may comprise any manufacture comprising a recording of the present information as described above, or a memory access means that can access such a manufacture.

A “processor” references any hardware and/or software combination which will perform the functions required of it. For example, any processor herein may be a programmable digital microprocessor such as available in the form of an electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

“Computer readable medium” as used herein refers to any storage or transmission medium that participates in providing instructions and/or data to a computer for execution and/or processing. Examples of storage media include floppy disks, magnetic tape, UBS, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer. A file may be stored in permanent memory.

With respect to computer readable media, “permanent memory” refers to memory that is permanently stored on a data storage medium. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RAM) is an example of non-permanent memory. A file in permanent memory may be editable and re-writable.

To “record” data, programming or other information on a computer readable medium refers to a process for storing information, using any such methods as known in the art. Any convenient data storage structure may be chosen; based on the means used to access the stored information. A variety of data processor programs and formats can be used for storage, e.g. word processing text file, database format, etc.

A “memory” or “memory unit” refers to any device which can store information for subsequent retrieval by a processor, and may include magnetic or optical devices (such as a hard disk, floppy disk, CD, or DVD), or solid state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices).

Items of data are “linked” to one another in a memory when the same data input (for example, filename or directory name or search term) retrieves the linked items (in a same file or not) or an input of one or more of the linked items retrieves one or more of the others.

### DETAILED DESCRIPTION OF THE INVENTION

Methods for transferring data, e.g., analytical device consumable data, from a source location to a target location are provided. Aspects of the invention include an interface element that presents the data to a user in a format that includes a first subset of the data and at least a second subset of the data. A feature of the interface of the invention is that, upon selection (e.g., via a one-click protocol), the first subset is output by the interface element to a product that includes the first subset of data. The product is then transferred to the target location, e.g., automatically or upon receipt of one or more additional user directions, e.g., where the product may be in a format that is universally understood by many different target locations, such that the format of the product is not tailored for a specific target location, but instead is in a format that may be employed by many different target locations. In certain embodiments, the source location is a publication (e.g., published by a vendor of a consumable) about the consumable, e.g., a catalog (paper or electronic), a web-page, etc., and the target location is an application program, e.g., either an “off-the-shelf” application program or a local system of a customer. Also provided are computer program products and systems for executing the subject methods.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

As summarized above, aspects of the invention include methods and systems for transferring information (i.e., data) from a source location to a target location. In further describing the aspects of the invention, a review of representative methods is provided first, followed by a review of representative systems for practicing the subject invention.

Methods

As summarized above, aspects of the invention provide methods of transferring data, e.g., analytical system consumable data, from a source location to a target location. While the invention is directed to the transfer of many different types of information from a source to a target location, particularly complex scientific information, the invention will further be described below in terms of an embodiment directed to the transfer of analytical device consumable data.

By analytical system consumable data is meant factual information about a consumable product that can be used in an analytical device. By consumable information is meant information about products that are not permanent parts of a given analytical device, such that they are meant or intended to last for the product lifetime of the analytical device, or at least a substantial portion thereof. Instead, consumable products are products that may be used once or a plurality of times, where when they are used for a plurality of times, the total amount of time they are used (i.e., the summation of the plurality of times) is a fraction of the product lifetime of the analytical device, i.e., less than about 50%, such as less than about 25%, including less than about 10%, less than about 5%, less than about 2%, less than about 1%, less than about 0.5% or less. As such, consumable products are distinguished from other types of analytical device products in that they are meant to be used for only a limited fraction of the product lifetime of the analytical device for which they are designed.

As mentioned above, the consumable products data that is transferred according to aspects of the invention is data about consumable products for analytical devices. The term “analytical device” is used broadly to refer to any type of device that performs an analysis of a sample. In many embodiments, the analytic device is an analytical chemistry device, which is a device that analyzes samples to gain an understanding of their chemical composition. Of interest in certain embodiments are consumables that find use in chromatographic devices, including both liquid and gas chromatographic devices. Of interest are consumables for use with the following representative analytical systems: Agilent Technologies GC or GC/MS systems, including 6890N GC, 5973 Inert MSD, 5973N GC/MS, 6850 Series II Network GC and 6850 Series Network GC, 3000 Micro GC, 6820 GC, etc.

The consumables of interest may be one time or limited use products. For example, consumables may be reagents that are used once in a given protocol. A representative embodiment of a consumable reagent is a chromatographic standard, which reagent is typically a fluid sample of known composition that includes a number of different calibrants (i.e., compounds used in calibration) in known quantities. Other representative reagents that may be sold as consumables for an analytical device include, but are not limited to: internal standards, solvents, and the like.

The consumables of interest may also be components or devices that are employed in a consumable manner with an analytical device, as described above, such that they need to be replaced after a single or multiple uses. An example of such a consumable for chromatographic analytical device is a separation column, e.g., a capillary column. Other representative consumable devices include, but are not limited to: inlet liners, guard columns, syringes, vials, well plates, and the like.

While the invention is suitable for use in transferring information about any analytical device consumable (i.e., for transferring any analytical device consumable data), for ease of further description only, the invention will be described in view of the representative embodiments of gas chromatography standards and gas chromatography columns. It should be noted, however, that the invention is not limited to these particular representative embodiments, as reviewed above.

As summarized above, the invention provides methods of transferring analytical system consumable data from a source location to a target location. By source location is meant a location, or locations, at which the information about the consumable is located. In certain embodiments, the source location is the provider of the consumable, e.g., the manufacturer of the consumable and/or the vendor of the consumable. In representative embodiments, the source location is an electronically accessible file or combination of files (or analogous collection of data), such as may be located at a website on the World Wide Web, a computer readable medium associated with the consumable, e.g., on the packaging thereof, or a file generated by an optical scanning device (e.g., a file generated by a scanning pen that scans information from the packaging of the consumable), etc.

A feature of the invention is the presence of an interface element (also referred to herein as an interface manager), which interface manager presents the consumable data to the user in the format of at least two subsets, i.e., a first subset and at least a second subset. The first subset of the data is the data that is to be transferred from the source to the target location, while the second subset of the data is the data that is to remain at the source location. As such, the first subset represents only a portion of the total data about the consumable that is present at the source location. The first subset may be made up of qualitative and/or quantitative data. For example, the first subset may include the names and relative amounts of the different calibrants in a given standard. Likewise, the first subset may include relevant information about a given column, such as name of the column, stationary phase composition, dimensions, temperature range parameters, etc. The second subset, and any other subsets, of information collectively make the remainder of the data about the analytical device consumable of interest.

A feature of the subject invention is that the interface manager provides the first subset in a manner such that, upon selection by a user, the first subset is output into a product, e.g., automatically, where the product of this outputting step has a format that is suitable for insertion, either directly or through one or more subsequent steps, into a target location. In many embodiments, the product is a collection of the first subset of information that is, as a whole or collectively, readily transferable from the source to target location, such as a computer accessible file.

Selection may be accomplished using any convenient format. In certain embodiments, the interface manager provides a graphical user interface (GUI) between the user and the source location. In these embodiments one may employ a selecting device, e.g., a mouse, to point and click on the consumable of interest. In one aspect, this “selecting” comprises a first user action sequence, which may, in one alternative, require only pointing of a pointer and a single-click on a button of the pointer device (e.g., mouse), the pointing and clicking being referred to herein as a “single-entry user action sequence”. In certain of these embodiments, the user selects the first subset of information with the pointer by pointing at the first subset of information on the GUI with the pointer and pressing a button of the pointing device and holding it down for a certain minimum time interval which the user may set or may be preset, with the pointer remaining in a substantially fixed position over the representation of the first subset of information before releasing the button. This pointing, pressing, holding and releasing is one embodiment of what is referred to herein as a first user action sequence. The above selection protocol is referred to as a “single entry action” because although it does require both movement of the pointing device and clicking of the pointing device button, it requires only a single click, that is all, only a single pressing and releasing of the button.

Upon selection, the interface manager outputs a product file from the source location(s). The output product may be formatted by the interface manager in a number of different configurations. For example where the consumable is a gas chromatograph standard, the product may have a format of listing all of the calibrants of the standard alphabetically. Alternatively, the format may list all of the calibrants by their representative amounts, e.g., highest to lowest amount, in the standard. In yet other embodiments, the format may list the calibrants in terms of elution time or order. The format of the product may be one that is predetermined, such that the product is provided in the same format to all users. In a variation, a user may be able to select from a number of different candidate formats, e.g., as requested by previous users, (and in certain embodiments ranked in terms of popularity), so that the format of the product is best suited for the target location. Alternatively, the format may be one that is customizable, such that prior to outputting the first subset of information to the product, one or more questions, e.g., in the form of one or more queries, are presented to the user, and the format of the product is determined, at least in part, based on response information provided by the user that was prompted by the one or more queries. For example, the user could select the given consumable, and, prior to producing the product, the system could query the user for one or more source location relevant parameters, e.g., nature of the analytical device being used, purpose of analytical protocol in which the consumable is to be employed, etc. Based on the response information provided by the user, the initial first subset of information could be tailored or processed, e.g., with one or more algorithms present at the source location, to provide an output that is customized for the user.

In certain embodiments, upon selection and output of product, the interface manager automatically transfers the product from the source location to the target location. Transfer may be via any convenient means, e.g., by download over the Internet, via email communication over the Internet, etc. In yet other embodiments, the product may be further evaluated prior to ultimate transfer to the source location. As such, the product may be one that is presented to the user, and the user may evaluate for acceptability according to one or more criteria, prior to introducing the product into the source location, e.g., via copying the product document and then pasting it into the target location.

The target location to which information is transferred via the subject methods may vary greatly. For example, the target location may be system for operating an analytical device, or a subsystem thereof. For example, the target location may be a system that runs or operates a chromatographic device, where the system includes instrument control, data acquisition and data evaluation subsystems. In many embodiments, the target location is, at least in part, a processing system that produces on or more outputs, e.g., reports, etc., based in part on the product of the first subset of information that is transferred to it by the subject methods. For example, where the product is made up of information about a GC standard, such as names of calibrants and amounts thereof, the target location may be a data system for use with a chromatographic device, such as the ChemStation™ data system from Agilent Technologies, Palo Alto, Calif. This representative data system includes instrument control, data acquisition and data evaluation subsystems. One or more of these subsystems may use the information of the input product during operation, e.g., in running the device properly, in evaluating the data, in report generation, etc.

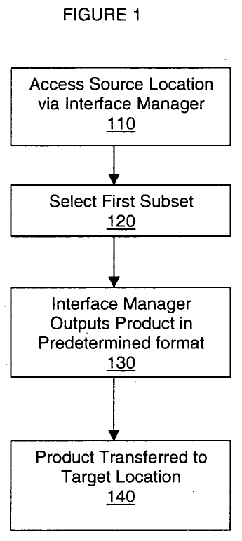

A first representative embodiment of the subject methods is depicted in FIG. 1. In FIG. 1, the first step 110 of the depicted method is for the user to access the source location, e.g., via the internet and through the interface manager. As reviewed above, the source location may be a webpage of a vendor of the consumable of interest. Next, the user selects the portion of the information about the consumable of interest, i.e., the user selects the first subset of total information about the consumable presented by the interface manager, as represented in box 120. As reviewed above, selection 120 may be done by a one-click protocol. At step 130 the interface manager outputs the data of the first subset into a product, where the product is arranged according to a predetermined format, e.g., a predetermined table or chart organization. At step 140, the product is then transferred to the target location, e.g., automatically over the Internet or vie an email to the user.

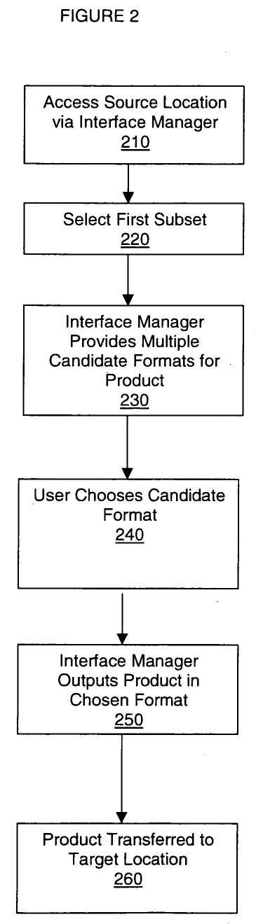

A second representative embodiment of the subject methods is depicted in FIG. 2. In FIG. 2, like the embodiment of FIG. 1, the first step 210 of the depicted method is for the user to access the source location, e.g., via the Internet and through the interface manager. As reviewed above, the source location may be a webpage of a vendor of the consumable of interest. Next, the user selects the portion of the information about the consumable of interest, i.e., the user selects the first subset of total information about the consumable presented by the interface manager, as represented in box 220. As reviewed above, selection 220 may be done by a one-click protocol. At step 130 the interface manager presents the user with two or more candidate formats for the output, where the number of candidate outputs may vary, e.g., 2 or more, 3 or more, 4 or more, 5 or more, 10 or more, 15 or more, etc. The candidate outputs may be displayed according to any convenient scheme, e.g., in terms of popularity of selection by other users, etc. At step 240, the user chooses the candidate format of interest. Then, at step 250, the interface manager outputs the data of the first subset into a product, where the product is arranged according to a chosen candidate format, e.g., the user selected table or chart organization. At step 260, the product is then transferred to the target location, e.g., automatically over the Internet or vie an email to the user.

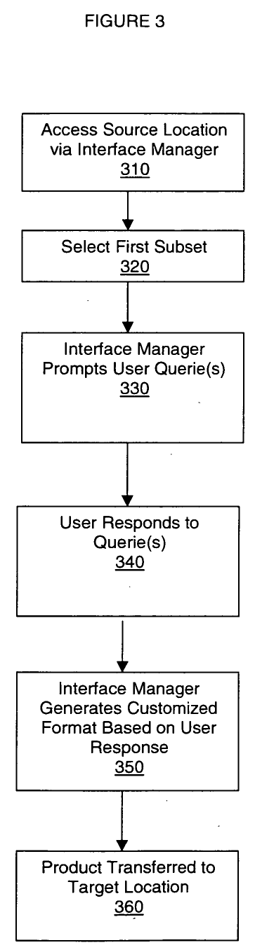

A third representative embodiment of the subject methods is depicted in FIG. 3. In FIG. 3, like the embodiment of FIG. 1, the first step 310 of the depicted method is for the user to access the source location, e.g., via the Internet and through the interface manager. As reviewed above, the source location may be a webpage of a vendor of the consumable of interest. Next, the user selects the portion of the information about the consumable of interest, i.e., the user selects the first subset of total information about the consumable presented by the interface manager, as represented in box 320. As reviewed above, selection 320 may be done by a one-click protocol. At step 330 the interface manager presents the user with one or more questions or queries, e.g., regarding the nature of the analytical device with which the consumable is to be employed, the nature of the report to be generated with the information about the consumable, etc. At step 340, the user responds to the one or more queries. At step 350, the interface manager outputs the data of the first subset into a product, where the product is arranged according to a customized format based on the response information provided by the user, e.g., a customized table or chart organization based on answers provided by the user to the questions presented by the interface manager. At step 360, the product is then transferred to the target location, e.g., automatically over the Internet or vie an email to the user.

A first representative embodiment involves the transfer of information about a standard from a vendor of the standard to a user. In this representative embodiment, a standard has 50 peaks which have names (complex and long) and quantitative information (units will vary). Normally, transfer of this information from the vendor to a document of the user, e.g., a report, would require that the user to enter (typically via keyboard) each of the names into a calibration table (a specific task within the domain of the data system). For each of the named peaks the corresponding quantitative information would also have to be entered. However, using the present invention, the user accesses the source location website and is offered the information (by the interface manager, as described above) in a form that is able to be copied and pasted directly into the target table/entry form.

In a second specific representative embodiment, the consumable of interest is a chromatography column. Generally, columns used in analytical system are typically entered into the system to be later identified on any reports generated through their use. Further, the geometry of the columns is used in some techniques to determine the specific instrument settings required to properly achieve the expected results (flow through a GC column as example). Using the present invention, this information is selected directly from the consumables webpage. Furthermore, the selection is augmented in certain embodiments with calculation algorithms which take user supplied information and “adjust” nominal information with “actual” information, e.g., to provide a customized output, as reviewed above. Once all adjustments are made the information can be recopied and use to update the data system.

As mentioned above, the invention is suitable for use in transferring information about any analytical device consumable (i.e., for transferring any analytical device consumable data). However, for ease of description only, the invention was described above in view of the representative embodiments of gas chromatography standards and gas chromatography columns. It should be noted, however, that the invention is not limited to these particular representative embodiments.

Systems

Also provided are systems for use in practicing the subject methods. Representative embodiments of the subject systems generally include the following components: (a) a communications module for facilitating information transfer between the system and one or more users, e.g., via a user computer, as described below; and (b) a processing module for performing one or more tasks in response to information received via the communications module of the system. In representative embodiments, the subject systems may be viewed as being the physical embodiment of a web portal, where the term “web portal” refers to a web site or service, e.g., as may be viewed in the form of a web page, that offers a broad array of resources and services to users via an electronic communication element, e.g., via the Internet. Each of these elements is described in greater detail below.

The subject systems may include both hardware and software components, where the hardware components may take the form of one or more platforms, e.g., in the form of servers, such that the functional elements, i.e., those elements of the system that carry out specific tasks (such as managing input and output of information, processing information, etc.) of the system may be carried out by the execution of software applications on and across the one or more computer platforms represented of the system.

The one or more platforms present in the subject systems may be any type of known computer platform or a type to be developed in the future, although they typically will be of a class of computer commonly referred to as servers. However, they may also be a main-frame computer, a work station, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows, Sun Solaris, Linux, OS/400, Compaq Tru64 Unix, SGI IRIX, Siemens Reliant Unix, and others.

In certain embodiments, the subject devices include multiple computer platforms which may provide for certain benefits, e.g., lower costs of deployment, database switching, or changes to enterprise applications, and/or more effective firewalls. Other configurations, however, are possible. For example, as is well known to those of ordinary skill in the relevant art, so-called two-tier or N-tier architectures are possible rather than the three-tier server-side component architecture represented by, for example, E. Roman, Mastering Enterprise JavaBeans™ and the Java™2 Platform (John Wiley & Sons, Inc., NY, 1999) and J. Schneider and R. Arora, Using Enterprise Java. (Que Corporation, Indianapolis, 1997).

It will be understood that many hardware and associated software or firmware components that may be implemented in a server-side architecture for Internet commerce are known and need not be reviewed in detail here. Components to implement one or more firewalls to protect data and applications, uninterruptable power supplies, LAN switches, web-server routing software, and many other components are not shown. Similarly, a variety of computer components customarily included in server-class computing platforms, as well as other types of computers, will be understood to be included but are not shown. These components include, for example, processors, memory units, input/output devices, buses, and other components noted above with respect to a user computer. Those of ordinary skill in the art will readily appreciate how these and other conventional components may be implemented.

The functional elements of system may also be implemented in accordance with a variety of software facilitators and platforms (although it is not precluded that some or all of the functions of system may also be implemented in hardware or firmware). Among the various commercial products available for implementing e-commerce web portals are BEA WebLogic from BEA Systems, which is a so-called “middleware” application. This and other middleware applications are sometimes referred to as “application servers,” but are not to be confused with application server hardware elements. The function of these middleware applications generally is to assist other software components (such as software for performing various functional elements) to share resources and coordinate activities. The goals include making it easier to write, maintain, and change the software components; to avoid data bottlenecks; and prevent or recover from system failures. Thus, these middleware applications may provide load-balancing, fail-over, and fault tolerance, all of which features will be appreciated by those of ordinary skill in the relevant art.

Other development products, such as the Java™2 platform from Sun Microsystems, Inc. may be employed in the system to provide suites of applications programming interfaces (API's) that, among other things, enhance the implementation of scalable and secure components. Various other software development approaches or architectures may be used to implement the functional elements of system and their interconnection, as will be appreciated by those of ordinary skill in the art.

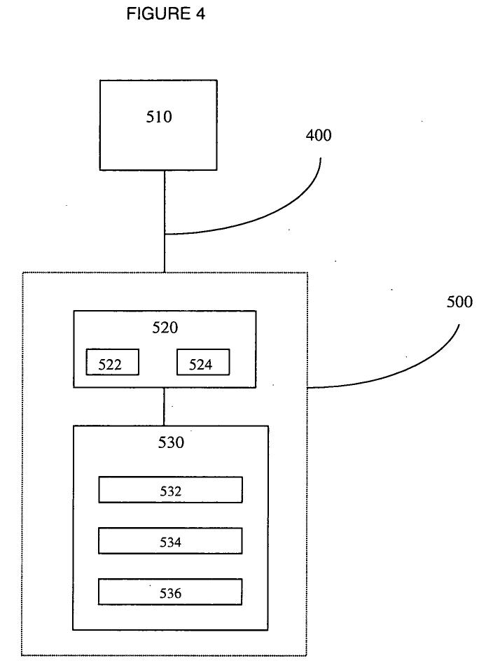

FIG. 4 provides a view of a representative system according to an embodiment of the subject invention. In FIG. 4, system 500 includes communications module 520 and processing module 530, where each module may be present on the same or different platforms, e.g., servers, as described above. The communications module includes the input manager 522 and output manager 524 functional elements. Input manager 522 receives information, e.g., request information, from a user e.g., over the Internet. Input manager 522 processes and forwards this information to the processing module 530. These functions are performed in accordance with known techniques common to the operation of Internet servers, also commonly referred to in similar contexts as presentation servers. Another of the functional elements of communications module 520 is output manager 524. Output manager 524 provides information assembled by processing module, e.g., the product having the first subset of information, to a user, e.g., over the Internet, also in accordance with those known techniques. The presentation of data by the output manager may be implemented in accordance with a variety of known techniques. As some examples, data may include HTML or XML documents, email or other files, or data in other forms. The data may include Internet URL addresses so that a user may retrieve additional HTML, XML, or other documents or data from remote sources.

The communications module 520 may be operatively connected to a user computer 510, which provides a vehicle for a user to interact with the system 500. User computer 510, shown in FIG. 4, may be a computing device specially designed and configured to support and execute any of a multitude of different applications. Computer 510 also may be any of a variety of types of general-purpose computers such as a personal computer, network server, workstation, or other computer platform now or later developed. Computer 510 typically includes known components such as a processor, an operating system, a graphical user interface (GUI) controller, a system memory, memory storage devices, and input-output controllers. It will be understood by those skilled in the relevant art that there are many possible configurations of the components of computer 510 and that some components are not listed above, such as cache memory, a data backup unit, and many other devices. The processor may be a commercially available processor such as a Pentium® processor made by Intel Corporation, a SPARC® processor made by Sun Microsystems, or it may be one of other processors that are or will become available. The processor executes the operating system, which may be, for example, a Windows®-type operating system (such as Windows) from the Microsoft Corporation; a Unix® or Linux-type operating system available from many vendors; another or a future operating system; or some combination thereof. The operating system interfaces with firmware and hardware in a well-known manner, and facilitates the processor in coordinating and executing the functions of various computer programs that may be written in a variety of programming languages, such as Java, Perl, C++, other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques.

The system memory may be any of a variety of known or future memory storage devices. Examples include any commonly available random access memory (RAM), magnetic medium such as a resident hard disk or tape, an optical medium such as a read and write compact disc, or other memory storage device. The memory storage device may be any of a variety of known or future devices, including a compact disk drive, a tape drive, a removable hard disk drive, or a diskette drive. Such types of memory storage devices typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor the computer, causes the processor to perform functions described herein. As such, the processor is configured by the program to perform the methods of the present invention. In other embodiments, some functions are implemented primarily in hardware using, for example, a hardware state machine. Implementation of the hardware state machine so as to perform the functions described herein will be apparent to those skilled in the relevant arts.

The input-output controllers of the computer could include any of a variety of known devices for accepting and processing information from a user, whether a human or a machine, whether local or remote. Such devices may include, for example, modem cards, network interface cards, sound cards, or other types of controllers for any of a variety of known input devices. Output controllers of input-output controllers could include controllers for any of a variety of known display devices for presenting information to a user, whether a human or a machine, whether local or remote. If one of the display devices provides visual information, this information typically may be logically and/or physically organized as an array of picture elements, sometimes referred to as pixels. A graphical user interface (GUI) controller may comprise any of a variety of known or future software programs for providing graphical input and output interfaces between the computer 510 and a user, and for processing user inputs. The functional elements of the computer 510 may communicate with each other via system bus. Some of these communications may be accomplished in alternative embodiments using network or other types of remote communications.

During use, a user employs the user computer to enter information into and retrieve information from the system. As shown in FIG. 4, Computer 510 is coupled via network cable 400 to the system 500. Additional computers of other users in a local or wide-area network including an Intranet, the Internet, or any other network may also be coupled to system 500 via cable 400. It will be understood that cable 400 is merely representative of any type of network connectivity, which may involve cables, transmitters, relay stations, network servers, and many other components not shown but evident to those of ordinary skill in the relevant art. Via user computer 510, a user may operate a web browser served by a user-side Internet client to communicate via Internet with system 500. System 500 may similarly be in communication over Internet with other users and/or networks of users, as desired.

In certain embodiments, the output manager further provides a user with information regarding how to purchase the consumable of interest. In certain embodiments, the information is provided in the form of an email. In certain embodiments, the information is provided in the form of web page content on a graphical user interface in communication with the output manager. In certain embodiments, the web page content provides a user with an option to select for purchase one or more consumables. In certain embodiments, the web page content includes fields for inputting customer information. In certain embodiments, the system can store the customer information in the memory. In certain embodiments, the customer information includes one or more purchase order numbers. In certain embodiments, the customer information includes one or more purchase order numbers and the system prompts a user to select a purchase order number prior to purchasing the one or more consumables.

As reviewed above, the systems include various functional elements that carry out specific tasks on the platforms in response to information introduced into the system by one or more users. In FIG. 4, elements 532, 534 and 536 represent three different functional elements of processing module 530. At least one of the elements 531, 534 and 536 enables the interface manager, as described above, and may be viewed as the interface manager functional element of the system.

The invention also provides programming, e.g., in the form of computer program products, for use in practicing the methods. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. One of skill in the art can readily appreciate how any of the presently known computer readable mediums can be used to create a manufacture that includes a recording of the present programming/algorithms for carrying out the above-described methodology.

It is evident from the above description that the subject invention provides a number of advantages. Advantages include the avoidance of time consuming steps in transcribing complex information, e.g., scientific names, units etc., as well as avoidance of errors that may arise transcribing such information. As such, the subject invention represents a significant contribution to the art.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A method of transferring analytical system consumable data from a source location to a target location, said method comprising:
accessing said source location, wherein said source location includes a first subset of analytical system consumable data and a second subset of analytical system consumable data, wherein an interface element presents said first subset in a format that, upon selection, is outputted by from said source location into a product comprising said first subset; and
selecting said first subset to transfer said product to said target location.

2. The method according to claim 1, wherein said product has a format that is predetermined.

3. The method according to claim 2, wherein said format is a user customized format.

4. The method according to claim 3, wherein said selecting comprises inputting response information prompted by a query and said customized format is generated based on said response information.

5. The method according to claim 2, wherein said format is not a user customized format.

6. The method according to claim 5, wherein said format is selected by a user from a plurality of candidate formats.

7. The method according to claim 1, wherein said first subset comprises quantitative data.

8. The method according to claim 1, wherein said first subset comprises qualitative data.

9. The method according to claim 1, wherein said first subset comprises quantitative and qualitative data.

10. The method according to claim 1, wherein said analytical system consumable data is for a chromatographic consumable.

11. The method according to claim 10, wherein said chromatographic consumable is a reagent.

12. The method according to claim 11, wherein said reagent is a standard.

13. The method according to claim 10, wherein said chromatographic consumable is a device.

14. The method according to claim 13, wherein said device is a column.

15. The method according to claim 1, wherein said target location is a system for operating an analytical device.

16. The method according to claim 15, wherein said system comprises at least one of instrument control, data acquisition and data evaluation subsystems.

17. The method according to claim 1, wherein said target location is a product file that is configured to be inserted into a second target location.

18. The method according to claim 1, wherein said source location is remote from said target location.

19. The method according to claim 18, wherein said method comprises communicating between said source and target location via the Internet.

20. The method according to claim 19, wherein said communicating is via a graphical user interface (GUI).

21. The method according to claim 1, wherein said source location is a vendor of analytical system consumables.

22. The method according to claim 21, wherein said source location is a website of said vendor.

23. A computer program product comprising a computer readable storage medium having a computer program stored thereon, wherein said computer program, when loaded onto a computer, operates said computer to:
provide for transfer of analytical system consumable data from a source location to a target location by:
(a) providing a source location, wherein said source location includes a first subset of analytical system consumable data and a second subset of analytical system consumable data, wherein an interface element presents said first subset in a format that, upon selection, is outputted by said source location into a product comprising said first subset; and
(b) an interface that allows selection of said first subset of analytical system consumable data to transfer said first subset of analytic system consumable data from said source location to said target location.

24. The computer readable medium according to claim 23, wherein said source location is remote from said target location.

25. The computer readable medium according to claim 24, wherein said method program provides for communication between said source and target location via the Internet.

26. The computer readable medium according to claim 23, wherein said interface is a graphical user interface (GUI).

27. A system for operating a source of analytical system consumable data, said system comprising:
a computer program product comprising a computer readable storage medium having a computer program stored thereon, wherein said computer program, when loaded onto a computer, operates said computer to:
provide for transfer of analytical system consumable data from a source location to a target location by:
(a) providing a source location, wherein said source location includes a first subset of analytical system consumable data and a second subset of analytical system consumable data, wherein an interface element presents said first subset in a format that, upon selection, is outputted by said source location into a product comprising said first subset; and
(b) an interface that allows selection of said first subset of analytical system consumable data to transfer said first subset of analytic system consumable data from said source location to said target location.

28. The system according to claim 27, wherein said source is a vendor website.

29. A method of providing analytical system consumable data by a source to a user, said method comprising:
employing an interface element to present said analytical system consumable data in a form that includes a first subset of analytical system consumable data and a second subset of analytical system consumable data, wherein said first subset is presented by said interface manager in a format that, upon selection, is outputted into a product comprising said first subset.
